(19) United States
(12) Patent Application Publication
(10) Pub. No.: US 2014/0087102 A1
(43) Pub. Date: Mar. 27, 2014

(54) AIR SEPARATION COLUMN LOW-DENSITY SOLID-STATE INSULATION PATENT

(71) Applicant: AIR LIQUIDE LARGE INDUSTRIES U.S. LP, Houston, TX (US)

(72) Inventors: Charles N. Harper, Houston, TX (US); John Somavarapu, Houston, TX (US)

(73) Assignee: Air Liquide Large Industries U.S. LP, Houston, TX (US)

(21) Appl. No.: 13/624,128

(22) Filed: Sep. 21, 2012

(51) Int. Cl. B32B 1/06; B32B 3/02

(52) U.S. Cl. 428/34.1; 428/68; 428/57; 428/58

(57) ABSTRACT

A cryogenic insulation system is proposed comprising enclosing at least a portion of a cryogenic device with low density high conductivity insulation material. The cryogenic device may be an air separation unit. The cryogenic device does not include an outer containment structure for granulated cryogenic insulation. The low density high conductivity insulation material may consists of at least one layer of abutting or overlapping low density high conductivity insulation material composite with fibrous batting. The portion of the cryogenic device is selected from the group consisting of: a distillation column, a heat exchanger, a condenser, a reboiler, an expansion turbine, valves, piping, or any combination thereof.

### TECHNICAL FIELD

The present invention relates to a low-density, solid-state insulation for cryogenic distillation.

### BACKGROUND

The existing method to insulate an air separation plant requires that the distillation columns be built within an enclosed structure that includes support columns and extension on valves for manipulation from the outside. The air separation column is enclosed within the structure to allow for an insulation material to be added after the outer structure is built to reduce heat leak that occurs during the cryogenic air separation process. The current insulation material is perlite that is blown in after the outer structure is complete. In order to perform maintenance and work on the column and related piping and instrumentation you will be required to remove the insulation material and work around the space as defined by the outer structure.

### SUMMARY

A cryogenic insulation system is proposed comprising enclosing at least a portion of a cryogenic device with a low density high conductivity insulation material applied directly to the column and process piping (example Aerogel). The cryogenic device (pump, column, piling, and chamber) may be an air separation distillation unit. The cryogenic device does not include an outer containment structure for granulated cryogenic insulation. The low density high conductivity insulation material may consists of at least one layer of abutting or overlapping low density high conductivity insulation material composite with fibrous batting. The portion of the cryogenic device is selected from the group consisting of: a distillation column, a heat exchanger, a condenser, a reboiler, an expansion turbine, valves, piping, or any combination thereof.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Aerogel is a low-density solid-state insulating material derived from a gel, in which the liquid component of the gel has been replaced with a gas. The result is a solid with extremely low density http://en.wikipedia.org/wiki/Aerogel—cite note—GuinnessRecord-0 and thermal conductivity. Low density high conductivity insulation materials are produced by extracting the liquid component of a gel through supercritical drying. This allows the liquid to be slowly drawn off without causing the solid matrix in the gel to collapse from capillary action, as would happen with conventional evaporation.

Despite their name, aerogels are rigid, dry materials and do not resemble a gel in their physical properties; the name comes from the fact that they are derived from gels. Low density high conductivity insulation materials are good thermal insulators because they almost nullify the three methods of heat transfer (convection, conduction, and radiation). They are good conductive insulators because they are composed almost entirely from a gas, and gases are very poor heat conductors. Silica low density high conductivity insulation material is especially good because silica is also a poor conductor of heat (a metallic low density high conductivity insulation material, on the other hand, would be less effective). They are good convective inhibitors because air cannot circulate through the lattice. Numerous attempts have been made to adapt the rigid, brittle low density high conductivity insulation material into a more flexible insulation blanket. One example may be found in U.S. Pat. No. 8,021,583.

The use of a low-density solid-state insulating material to wrap the air separation columns has several benefits. It eliminates the need to build the outer structure to house the air separation column, thereby considerably reducing initial construction and capital cost. The long stem valves required to manipulate the air separation process are eliminated since the outer structure and resultant valve stem extensions are not required. Long term process maintenance, operator and instrumentation checks and calibrations are more easily made and overall reliability is improved due to maintainability. More importantly, the low-density solid-state insulating material provides a far greater degree of insulation to the air separation process, decreasing heat loss and dramatically increasing the plant process efficiency.

When air separation column maintenance or valve or pipe repairs are required, platforms will be erected to allow access to the column area, pipes or valves requiring repair. With the existing air separation column and outer structure in place, the cost to remove the perlite and re-installing after repairs is eliminated, dramatically reducing the repair cost and the plant down time. The use of perlite is also a problem due to potential cold box leaks that result in compacted moisture that is frozen when a leak occurs. This requires removal of a section or sections of the outer shell to remove the compacted perlite, and likely the removal of all perlite and purchase and installation of new.

A cryogenic insulation system is proposed comprising enclosing at least a portion of a cryogenic device with low density high conductivity insulation material. The cryogenic device may be an air separation unit. The cryogenic device does not include an outer containment structure for granulated cryogenic insulation. The low density high conductivity insulation material may consists of at least one layer of abutting or overlapping low density high conductivity insulation material composite with fibrous batting. The portion of the cryogenic device is selected from the group consisting of: a distillation column, a heat exchanger, a condenser, a reboiler, an expansion turbine, valves, piping, or any combination thereof.

What is claimed is:

1. A cryogenic insulation system comprising enclosing at least a majority of a cryogenic device with low density high conductivity insulation material.

2. The cryogenic insulation system of claim 1, wherein said cryogenic device is an air separation unit.

3. The cryogenic insulation system of claim 1, wherein said cryogenic device does not include an outer containment structure for granulated cryogenic insulation.

4. The cryogenic insulation system of claim 1, wherein said low density high conductivity insulation material consists of at least one layer of abutting or overlapping low density high conductivity insulation material composite with fibrous batting.

5. The cryogenic insulation system of claim 1, wherein said at least a portion of said cryogenic device is selected from the group consisting of: a distillation column, a heat exchanger, a condenser, a reboiler, an expansion turbine, valves, piping, or any combination thereof.
